(19) United States
(12) Patent Application Publication
(10) Pub. No.: US 2007/0028257 A1
(43) Pub. Date: Feb. 1, 2007

(54) Broadcasting signal receiver and method for displaying channel information

(75) Inventors: Jung-hwa Choi, Seoul (KR); Young-joo Seo, Suwon-si (KR); Kyung-sub Joo, Yongin-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/492,100

(22) Filed: Jul. 25, 2006

(30) Foreign Application Priority Data
Aug. 1, 2005 (KR) 2006-0070293

(51) Int. Cl. H04N 7/16; G06F 3/00; G06F 13/00; H04N 5/445

(52) U.S. Cl. 725/28; 725/29; 725/45; 725/46; 725/56

(57) ABSTRACT

A broadcasting signal receiver and a channel information displaying method of the broadcasting signal receiver are provided for displaying channel information in a channel information menu in which broadcast channels comprising broadcasting signals are classified into information regarding viewable channels and non-viewable channels separately displayed. Broadcast channels comprising broadcasting signals are searched. A viewable channel authorized for viewing and a non-viewable channel not authorized for viewing, among the searched broadcast channels are classified. A channel information menu is displayed comprising a first display block displaying information regarding the viewable channel and a second display block displaying information regarding the non-viewable channel.

### CROSS-REFERENCE TO RELATED APPLICATIONS

This application claims the benefit under 35 U.S.C. §119(a) of Korean Patent Application No. 2005-0070293, filed on Aug. 1, 2005, in the Korean Intellectual Property Office, the entire disclosure of which is hereby incorporated by reference.

### BACKGROUND OF INVENTION

1. Field of Invention

The present invention relates to a broadcasting signal receiver and a method for displaying channel information of the same. More particularly, the present invention relates to a broadcasting signal receiver and a method for displaying channel information, where a channel information menu classifies, among broadcast channels comprising broadcasting signals, viewable channels and non-viewable channels.

2. Description of the Related Art

In general, a terrestrial broadcasting, cable broadcasting, and satellite broadcasting transmit an image signal and a sound signal, information regarding a channel comprising a broadcasting signal and additional information regarding a program provided through corresponding channels. The additional information comprises, for example, Electronic Program Guide (EPG) information.

A broadcasting signal receiver, such as, a television (TV) and a Set-Top Box, provides a user with information regarding the channels comprising broadcasting signals, and the additional information regarding a program provided by each channel, by displaying the information in a channel information menu based on the EPG information.

FIG. 1 and FIG. 2 are drawings illustrating the channel information menus 180a and 180b provided in a conventional broadcasting signal receiver. As illustrated in the drawings, the conventional broadcasting signal receiver searches the channels comprising the broadcasting signal, among all channels, and provides a list of the searched channels together with information corresponding to the channels.

However, in the conventional broadcasting signal receiver, the channels comprising the broadcasting signal are listed and displayed in the channel information menus 180a and 180b in a predetermined order, such as, channel number order. In this instance, channels that do not comprise a normal broadcasting signal, such as, channels having only band energy without a normal broadcasting signal and scrambled channels for which a user does not have authority to view, are also included and displayed in the channel list. As a result, the user may have difficulties searching the channels which are authorized for viewing.

### SUMMARY OF THE INVENTION

An aspect of exemplary embodiments of the present invention is to address at least the above problems and/or disadvantages and to provide at least the advantages described below. Accordingly, an aspect of exemplary embodiments of the present invention is to provide a broadcasting signal receiver and a method for displaying channel information of the same, capable of providing a channel information menu in which the broadcast channels comprising broadcasting signals are classified into information regarding viewable channels and non-viewable channels, which are separately displayed.

Therefore, a user can readily search the viewable channels when the broadcast channels, comprising the broadcasting signal, are classified into viewable channels, authorized for viewing, and non-viewable channels, not authorized for viewing, and then displayed separately in the channel information menu.

The foregoing and/or other aspects of exemplary embodiments of the present invention can be achieved by providing a channel information displaying method of a broadcasting signal receiver where broadcast channels comprising broadcasting signals are searched, a viewable channel authorized for viewing and a non-viewable channel not authorized for viewing are classified among the searched broadcast channels, and a channel information menu is displayed in which a first display block displays information on the viewable channel and a second display block displays information on the non-viewable channel.

According to an aspect of an exemplary embodiment the present invention, the classifying of the viewable channels and the non-viewable channel comprise determining whether the broadcasting signals received through the respective broadcast channels are capable of being decoded. A channel, among the broadcast channels, comprising the broadcasting signal capable of being decoded is classified as the viewable channel. A channel comprising the broadcasting signal incapable of being decoded is classified as the non-viewable channel.

According to an aspect of an exemplary embodiment of the present invention, band energy of each channel is detected. The channel in which the band energy is detected is determined as the broadcast channel.

According to an aspect of an exemplary embodiment of the present invention, information regarding a changing procedure for changing the non-viewable channel to the viewable channel is displayed in the second display block.

According to an aspect of an exemplary embodiment of the present invention, the information regarding the changing procedure for changing the non-viewable channel to the viewable channel is provided from Electronic Program Guide information.

According to an aspect of an exemplary embodiment of the present invention, at least one of the viewable channels displayed in the channel information menu is selected. The channel is changed into the selected viewable channel.

The foregoing and/or another aspects of exemplary embodiments of the present invention can be achieved by providing a broadcasting receiver that comprises a UI generating unit, where a controller searches broadcast channels comprising broadcasting signals, a viewable channel and a non-viewable channel are classified among the searched broadcast channels, and the UI generating unit is controlled to generate a channel information menu. The channel information menu comprises a first display block displaying information regarding the viewable channel and a second display block displaying information regarding the non-viewable channel.

According to an aspect of an exemplary embodiment of the present invention, the controller comprises a decoder decoding the broadcasting signal of the broadcast channel. A microcomputer classifies, among the broadcast channels, a channel as the viewable channel comprising the broadcasting signal capable of being decoded by the decoder and a channel as the non-viewable channel comprising the broadcasting signal incapable of being decoded by the decoder.

According to an aspect of an exemplary embodiment of the present invention, a channel demodulator detects whether band energy exists in each channel and the channel in which the band energy is detected is searched as the broadcast channel.

According to an aspect of an exemplary embodiment of the present invention, an identifying unit identifies whether the broadcast channel is permitted for viewing, wherein the controller receives information regarding the broadcast channel from the identifying unit.

According to an aspect of an exemplary embodiment of the present invention, the controller controls the UI generating unit to display information in the second display block, based on EPG information, regarding a changing procedure for changing the non-viewable channel to the viewable channel.

According to an aspect of an exemplary embodiment of the present invention, a user input unit selects at least one of the viewable channels displayed in the channel information menu, wherein the controller changes a channel into the selected viewable channel through the user input unit.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 and FIG. 2 are drawings illustrating examples of a channel information menu provided from a conventional broadcasting receiver;

FIG. 3 is a schematic control block diagram of a broadcasting signal receiver according to an exemplary embodiment of the present invention;

FIG. 4 is a drawing illustrating an exemplary configuration of a controller in the broadcasting signal receiver of FIG. 3;

FIG. 5 is a drawing illustrating an example of a channel information menu provided from the broadcasting signal receiver according to an exemplary embodiment of the present invention;

FIG. 6 is a control flowchart for describing a method for displaying channel information of the broadcasting signal receiver according to an exemplary embodiment of the present invention.

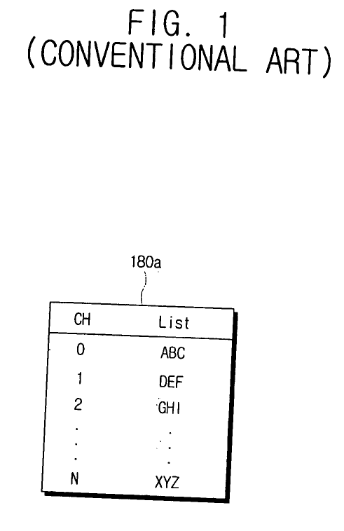

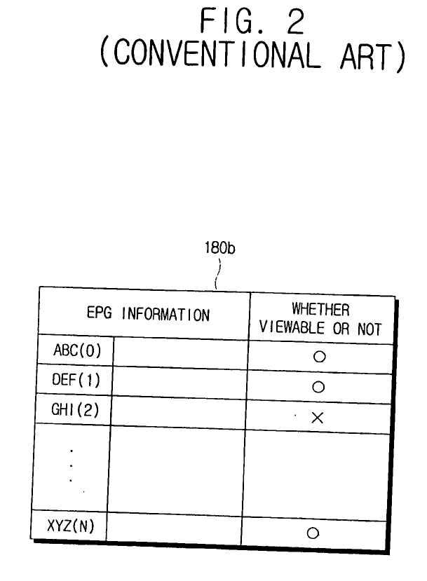

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

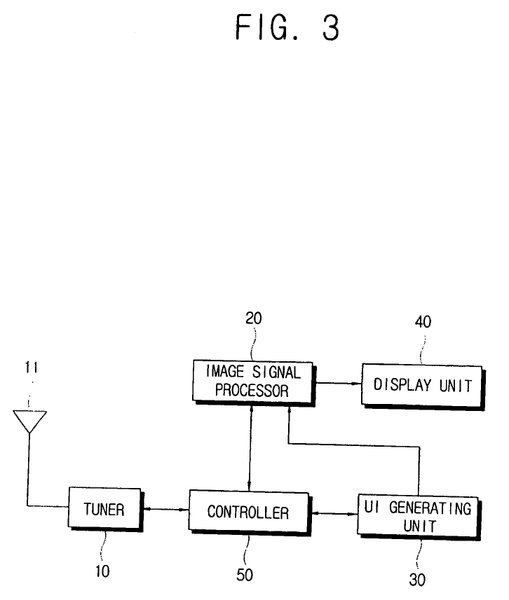

As illustrated in FIG. 3, a broadcasting signal receiver, according to an exemplary embodiment of the present invention, comprises a tuner 10, image signal processor 20, user interface (UI) generating unit 30 and controller 50. The broadcasting signal receiver may further comprise a display unit 40 in which an image signal from the image signal processor 20 may be displayed as an image.

The image signal transformed by the image signal processor 20 is applied to the display unit 40 to be displayed as the image on a screen. The display unit 40 may be one of a cathode ray tube (CRT), liquid crystal display (LCD) plasma display panel (PDP), or any type of display that can display an image.

The image signal processor 20 transforms the image signal applied from the controller 50 into a format such as a digital RGB signal capable of displaying the image in the display unit 40, and then outputs the image to the display unit 40. The image signal processor 20 may transform the image signal from the controller 50 to adjust a vertical frequency, resolution, and picture ratio, which corresponds to an output standard of the display unit 40.

The UI generating unit 30 displays a channel information menu 80 on the display unit 40 according to control of the controller 50. The image signal for generating the channel information menu 80 output from the UI generating unit 30 is displayed on the screen of the display unit 40 through the image signal processor 20.

The tuner 10 tunes the broadcasting signal received through an antenna 11 to a channel having the corresponding frequency band according to a tuning control signal of the controller 50. The broadcasting signal of the tuned channel is received in packet form of at least one of a transport stream, which is time-divided and multiplexed, video signal, audio signal and other various data.

The controller 50 transforms the broadcasting signal provided on a selected channel by the tuner 10 into a format which the image signal processor 20 can process and then output.

Also, the controller 50 searches a channel having the broadcasting signal (referred to herein as a broadcast channel) among channels received through the tuner 10. The controller 50 then classifies the channels among the searched broadcast channels received through the tuner 10 as viewable channels, which are authorized for viewing and non-viewable channels, which are not authorized for viewing.

The controller 50 controls the UI generating unit 30 to display the channel information menu 80 on the display unit 40. The channel information menu 80 comprises a first display block 81 displaying information regarding the viewable channels, and a second display block 82 displaying information regarding the non-viewable channels. The broadcasting signals comprised in the channels are classified into the viewable channels, capable of normally viewing, and the non-viewable channels. The classified channels are then provided to a user. Accordingly, the user can more readily search the viewable channels capable of normally viewing.

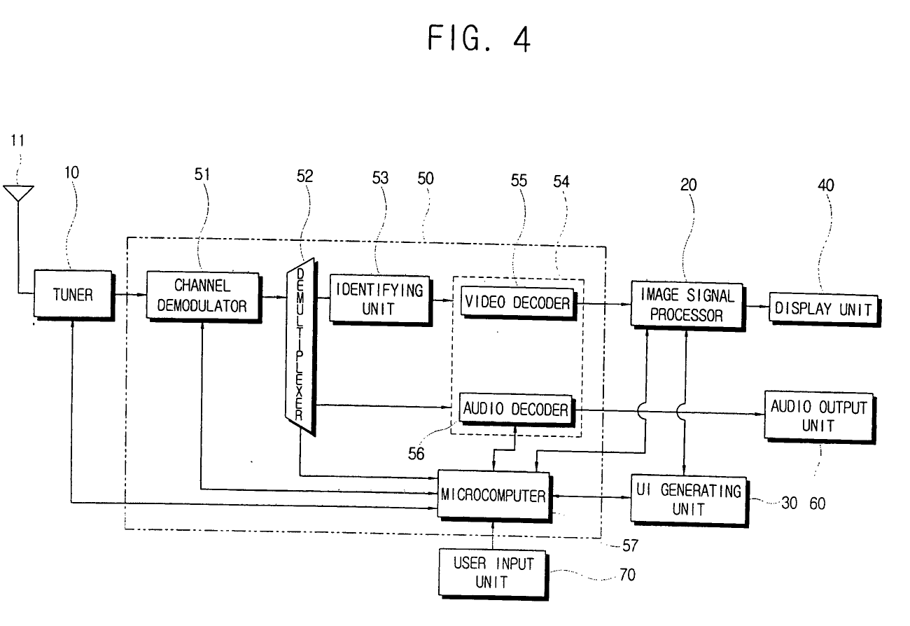

As described below, the broadcasting signal receiver, according to an exemplary embodiment of the present invention, is explained in more detail by referring to FIG. 4. The reference numerals referred to in FIG. 4 are the same elements as illustrated in FIG. 3. Therefore, an explanation of the reference numerals is omitted for clarity and conciseness.

The controller 50, according to an exemplary embodiment of the present invention, may comprise a channel demodulator 51, demultiplexer 52, identifying unit 53, decoder 54 and microcomputer (MICOM) 57.

The channel demodulator 51 outputs the broadcasting signal comprised in a specific channel selected by the tuner 10 in the form of a transport stream through a demodulation process and an error correction process. The demultiplexer 52 separates the broadcasting signal of the transport stream output from the channel demodulator 51 into a video stream, audio stream and data stream. The demultiplexer 52 then outputs the video stream, audio stream and data stream.

The video stream separated in the demultiplexer 52 is decoded by a video decoder 55, such as, a MPEG decoder, comprised in decoder 54, and is input to the image signal processor 20. Also, the audio stream separated in the demultiplexer 52 is decoded by an audio decoder 56 comprised in the decoder 54 and is output through an audio output unit 60 comprising a speaker.

Also, various data streams, separated in the demultiplexer 52, are parsed by a parsing unit (not shown) and then separately stored in a memory (not shown) according to each data table. The data stream being transmitted may comprise the Electronic Program Guide (EPG) information.

The identifying unit 53 identifies whether the user has an authority, which permits viewing of the broadcasting signal comprised in the broadcast channel. For example, if the channel including the broadcasting signal, which is scrambled, is authorized for the present user to view, the identifying unit 53 descrambles the corresponding broadcasting signal.

On the other hand, the MICOM 57 searches the broadcast channels comprising the broadcasting signal. According to an exemplary embodiment of the present invention, the MICOM 57 controls the channel demodulator 51 to detect whether band energy exists in each channel. If band energy exists, the MICOM 57 receives information regarding the channel as the broadcast channel, which comprises the band energy from the channel demodulator 51 and may search the channel.

Furthermore, the MICOM 57, according to an exemplary embodiment of the present invention, may receive information regarding the broadcast channel from the identifying unit 53. In this instance, a broadcasting provider may transmit all channels and programs provided, such as a viewable channel and non-viewable channel, or a scrambled channel and corresponding programs including various information corresponding thereto.

Among the detected broadcast channels, the MICOM 57 classifies the viewable channels and the non-viewable channels according to the above described method. The MICOM 57 also classifies the viewable channels and the non-viewable channels based on whether the decoder 54 can decode the broadcasting signal of each detected broadcast channel. In other words, the MICOM 57 classifies channels, among the broadcast channels, comprising the broadcasting signals capable of being decoded by the decoder 54 as the viewable channels, and channels, among the broadcast channels, comprising the broadcasting signal incapable of being decoded by the decoder 54 as the non-viewable channels.

Also, when the user selects a display of the channel information menu 80 through an operation of a user input unit 70, the MICOM 57 controls the UI generating unit 30 to display the channel information menu 80. The channel information menu 80 comprises the first display block 81 displaying information on the viewable channels and the second display block 82 displaying information on the non-viewable channels on display through the display unit 40.

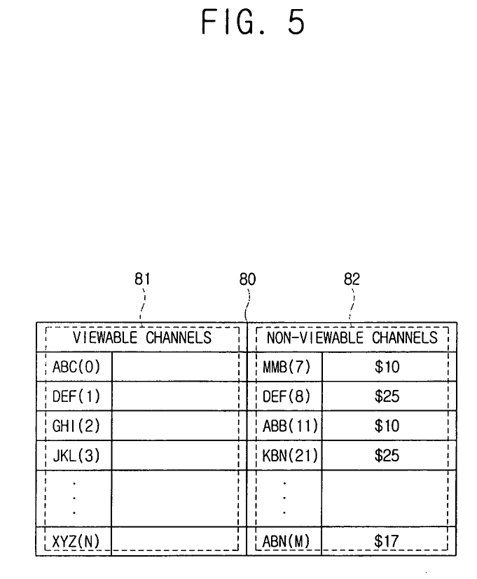

FIG. 5 is a drawing illustrating a channel information menu 80 provided through a broadcasting signal receiver according to an exemplary embodiment of the present invention.

As illustrated in the drawing, the first display block 81 displaying a list of the viewable channels and program information of each viewable channel is provided in the channel information menu 80. The program information of each viewable channel is generated based on EPG information, and may comprise content and time information of the corresponding program.

Also, a list of the non-viewable channels is displayed in the second display block 82 of the channel information menu 80. Information regarding a changing procedure for changing the non-viewable channels to the viewable channels may be displayed in the second display block 82. For example, the non-viewable channel, such as, a scramble channel corresponds to a payable channel in which an additional cost is required for viewing. Information regarding the additional cost for viewing the non-viewable channel may be displayed in the second display block 82. Also, when the viewable channels are determined according to a viewing grade of a present user, information regarding the viewing grade may correspond to the non-viewable channels and then displayed. In an exemplary implementation, information regarding the changing procedure for changing the non-viewable channels to the viewable channels may be provided in the EPG information.

On the other hand, when the user selects one of the viewable channels displayed in the first display block 81 of the channel information menu 80 through the user input unit 70, the MICOM 57 may control the tuner 10 to change a channel into the selected viewable channel. Accordingly, the user uses the channel list of viewable channels displayed in the channel information menu 80 to readily confirm and change the channel capable of viewing.

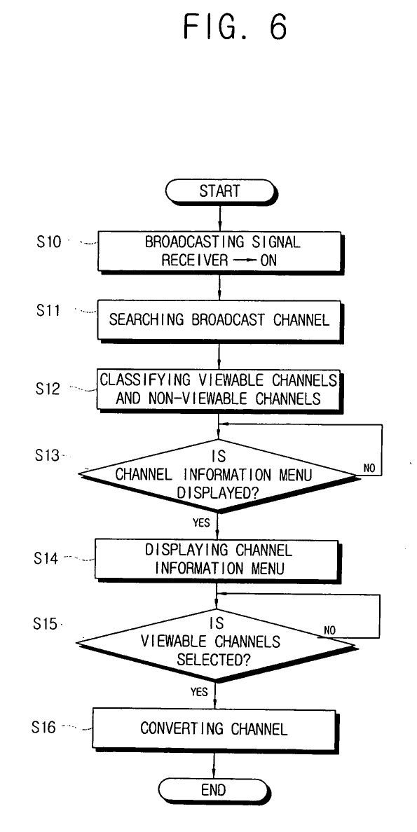

Referring to FIG. 6, a method for displaying channel information of a broadcasting signal receiver according to an exemplary embodiment of the present invention will be described.

After a broadcasting signal receiver is turned-on at operation S10, a controller 50 searches a broadcast channel among received channels through a tuner 10 at operation S11. The controller 50 classifies the searched broadcast channels into viewable channels and non-viewable channels at operation S12. A searching procedure and classifying procedure of the viewable channels and the non-viewable channels are controlled by the controller 50.

When the user selects to display a channel information menu 80 through an operation of a user input unit 70 at operation S13, the controller 50 controls a UI generating unit 30 to display the channel information menu 80 as illustrated in FIG. 5 on a display unit 40 at operation S14.

When the user selects at least one of the viewable channels provided in the channel information menu 80 through the user input unit 70 at operation S15, the controller 50 controls the tuner 10 to change the channel into the selected viewable channel.

As described above, the broadcasting signal receiver according to exemplary embodiments of the present invention comprises one of a digital TV or a Set-Top Box. When the broadcasting signal receiver, according to an exemplary embodiment of the present invention, comprises the Set-Top Box, the display unit 40, as illustrated in FIG. 3 and FIG. 4, may not be implemented in configuration elements of the broadcasting signal receiver. Also, the display unit 40 may comprise an additional output unit capable of outputting the broadcasting signal processed in a display device, such as, the TV.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A channel information displaying method of a broadcasting signal receiver, the method comprising:
searching broadcast channels comprising broadcasting signals;
classifying, among the searched broadcast channels, a viewable channel authorized for viewing and a non-viewable channel not authorized for viewing; and
displaying a channel information menu comprising a first display block displaying information regarding the viewable channel and a second display block displaying information regarding the non-viewable channel.

2. The channel information displaying method according to claim 1, wherein the classifying of the viewable channel and the non-viewable channel comprises:
determining whether the broadcasting signals received through the respective broadcast channels are capable of being decoded;
classifying, among the broadcast channels, a channel comprising the broadcasting signal capable of being decoded as the viewable channel;
classifying, among the broadcast channels, a channel comprising the broadcasting signal incapable of being decoded as the non-viewable channel.

3. The channel information displaying method according to claim 2, wherein the searching of the broadcast channels comprises detecting a band energy of each of the broadcast channels, and determining the channel comprising the detected band energy, as the broadcast channel.

4. The channel information displaying method according to claim 2, wherein the displaying of the channel information menu comprises displaying information in the second display block regarding a changing procedure for changing the non-viewable channel to the viewable channel.

5. The channel information displaying method according to claim 4, wherein the information regarding the changing procedure is provided from Electronic Program Guide (EPG) information.

6. The channel information displaying method according to claim 5, further comprising:
selecting at least one of the viewable channels displayed in the channel information menu; and
changing the channel into the selected viewable channel.

7. The channel information displaying method according to claim 4, further comprising:
selecting at least one of the viewable channels displayed in the channel information menu; and
changing the channel into the selected viewable channel.

8. The channel information displaying method according to claim 3, further comprising:
selecting at least one of the viewable channels displayed in the channel information menu; and
changing the channel into the selected viewable channel.

9. The channel information displaying method according to claim 2, further comprising:
selecting at least one of the viewable channels displayed in the channel information menu; and
changing the channel into the selected viewable channel.

10. The channel information displaying method according to claim 1, further comprising:
selecting at least one of the viewable channels displayed in the channel information menu; and
changing the channel into the selected viewable channel.

11. A broadcasting signal receiver, comprising:
a user interface (UI) generating unit; and
a controller for searching broadcast channels comprising broadcasting signals, classifying, among the searched broadcast channels, a viewable channel and a non-viewable channel and controlling the UI generating unit to generate a channel information menu,
wherein the channel information menu comprises a first display block displaying information regarding the viewable channel and a second display block displaying information regarding the non-viewable channel.

12. The broadcasting signal receiver according to claim 11, wherein the controller comprises:
a decoder for decoding the broadcasting signals of the broadcast channels;
a microcomputer for classifying, among the broadcast channels, a channel comprising the broadcasting signal capable of being decoded by the decoder as the viewable channel and a channel comprising the broadcasting signal incapable of being decoded by the decoder as the non-viewable channel.

13. The broadcasting signal receiver according to claim 12, wherein the controller further comprises a channel demodulator for detecting whether each channel comprises a band energy and searching the channel comprising the band energy, as the broadcast channel.

14. The broadcasting signal receiver according to claim 12, further comprising:
an identifying unit for identifying whether at least one of the broadcast channels is authorized for viewing,
wherein the controller receives information regarding the at least one of the broadcast channels from the identifying unit.

15. The broadcasting signal receiver according to claim 14, wherein the controller controls the UI generating unit to display information in the second display block, based on EPG information, regarding a changing procedure for changing the non-viewable channel to the viewable channel.

16. The broadcasting signal receiver according to claim 15, further comprising
a user input unit for selecting at least one of the viewable channels displayed in the channel information menu,
wherein the controller changes a channel into the selected viewable channel through the user input unit.

17. The broadcasting signal receiver according to claim 14, further comprising
a user input unit for selecting at least one of the viewable channels displayed in the channel information menu,
wherein the controller changes channels into the selected viewable channels through the user input unit.

18. The broadcasting signal receiver according to claim 13, further comprising
a user input unit for selecting at least one of the viewable channels displayed in the channel information menu,
wherein the controller changes channels into the selected viewable channels through the user input unit.

19. The broadcasting signal receiver according to claim 12, further comprising
a user input unit for selecting at least one of the viewable channels displayed in the channel information menu,
wherein the controller changes channels into the selected viewable channels through the user input unit.

20. The broadcasting signal receiver according to claim 11, further comprising
a user input unit for selecting at least one of the viewable channels displayed in the channel information menu,
wherein the controller changes channels into the selected viewable channels through the user input unit.
